(19) United States
(12) Patent Application Publication
(10) Pub. No.: US 2019/0120413 A1
(43) Pub. Date: Apr. 25, 2019

(54) A COUPLING DEVICE

(71) Applicant: GROZ ENGINEERING TOOLS (P) LTD., Gurgaon (IN)

(72) Inventor: Sunil VERMA, Gurgaon (IN)

(21) Appl. No.: 15/558,502

(22) PCT Filed: Feb. 13, 2017
(86) PCT No.: PCT/IN2017/050057

§ 371 Date: Sep. 14, 2017

(30) Foreign Application Priority Data
Dec. 12, 2016 (IN) 201611042391

(51) Int. Cl. F16L 37/12; F16L 37/20; F16N 21/04

(52) U.S. Cl. CPC F16L 37/121; F16N 21/04; F16L 37/20

(57) ABSTRACT

The problem to be solved is to provide a coupling device (10) that provides efficient engaging and disengaging of the nipple (62) with the coupling device (10) and especially that provides quick release of the nipple (62) with the coupling device (10) after flow of grease through it at high velocity and pressure without exerting excessive pressure on the coupling device (10) by the user, and the problem is solved by providing a coupling device (10) as in present invention that includes a lever (40) with a linkage mechanism that has a roller (48), which movably connects the lever (40) to the slider to move the slider axially forward and backward to disengage and engage the clamping unit (50) with the nipple (62) of the grease fitting by releasing and applying pressure exerted by a protrusion (32) structured at the end of the slider (30) opposite to the side facing the lever (40). FIG. 1 is the representative figure.

### CROSS-REFERENCE TO RELATED APPLICATIONS

This application claims priority to and the benefit of PCT Application PCT/IN2017/050057 filed on Feb. 13, 2017 and Indian Patent Application No. 201611042391, filed on Dec. 12, 2016, the disclosures of which are incorporated herein by reference in their entirety.

### BACKGROUND

### Field of the Invention

The present invention relates to a coupling device, and more particularly relates to the grease coupling device like hydraulic coupler that can securely hold grease fitting of various shapes and sizes, and provides an ease in engaging and disengaging of grease fitting from the coupling device.

### Description of the Related Art

The coupling devices or couplers are used since many years to connect with the hosepipes of grease guns and the nipple of grease fittings so that the viscous liquids such as grease, lubricant or the like as pumped from the grease pumping equipment such as grease guns, grease pumps or the like can be transferred through the hosepipe to the part that requires greasing or lubrication which is connected to the hose pipe through the grease fitting and the coupling device. However, it has been observed that excessive physical force is required to connect and disconnect the coupler with the nipple of the grease fittings. In the conventional coupler, usually a matching structure configuration is used wherein the coupler is pushed by the user against the nipple to connect the coupler with the nipple. It is therefore difficult to ascertain that the coupling between the coupler and the nipple would be able to withstand the high pressure of grease flowing through them. Additionally, disengaging or disconnecting of the coupler with the nipple after continuous flow of grease at high pressure becomes very difficult due to the inbuilt pressure created by the flow of grease. Thus, this would require additional effort by the user to disengage the nipple from the coupler that may lead to physical injury to the user and may damage the coupler preventing its reuse. In certain cases, the nipple of the grease fitting may also get damaged due to excessive physical effort to disengage coupler with nipple that would again add additional cost in its repairing and along with cost for replacement of coupler.

U.S. Pat. No. 6,375,227 disclose a coupler that has an annular sleeve that displaces laterally to lock the nipple. A collar as disclosed in this document moves the annular sleeve between two extreme positions to lock and unlock the nipple. However, the collar connected with annular sleeve fails to provide efficient engagement and disengagement of the nipple, and especially fails to provide quick release or disengagement of the nipple after the flow of grease through it because of pressure created in the coupler due to flow of grease at high velocity and pressure. Additionally, under such condition, excessive manual pressure is required to disengage the nipple with the coupler by the user, which needs efficient gripping for the user, which the coupler as disclosed in this document failed to provide. This would result in slipping of the user's finger or thumb while disengaging or engaging the coupler with the nipple, further resulting in injuring user, and additionally may damage the coupler when excessive force is applied to disengage after flow of fluid or grease through it.

The problem to be solved is to provide a coupling device that provides efficient engaging and disengaging of the nipple with the coupling device and especially that provides quick release of the nipple with the coupling device after flow of grease through it at high pressure conditions without exerting excessive pressure on the coupling device by the user, and the problem is solved by providing a coupling device as in present invention that includes a lever with a linkage mechanism that has a roller, which movably connects the lever to the slider to move the slider axially forward and backward to disengage and engage the clamping unit with the nipple of the grease fitting by releasing and applying pressure exerted by a protrusion structured at the end of the slider opposite to the side facing the lever.

### SUMMARY

An embodiment of the present invention discloses a coupling device comprising an elongated body including a front end, a rear end and a passage between said rear end and said front end, a slider with a protrusion axially movable along said elongated body between a first position and a second position on said elongated body, a lever including a linkage mechanism with a roller that movably connects said lever to said slider to axially move said slider between said first position and said second position when force is applied by a user, a clamping unit structured at said front end of said elongated body and detachably connected with said protrusion at an end of said slider opposite to said lever to engage and disengage with a nipple of a grease fitting, wherein said slider moves axially forward along said elongated body from said first position to said second position to move said protrusion exerting pressure on said clamping unit thereby releasing pressure from said clamping unit to allow retraction of said clamping unit when force is applied on said lever by said user, and said slider moves axially backward along said elongated body from said second position to said first position to move said protrusion on said clamping unit to exert pressure on said clamping unit thereby contracting said clamping unit when force is released from said lever.

An embodiment of the present invention discloses that clamping unit retracts to disengage said nipple of said grease fitting with said elongated body, and said clamping unit contracts to engage said nipple of said grease fitting with said elongated body.

An embodiment of the present invention discloses that clamping unit includes plurality of spherical heads structured circumferentially along an inner surface of said front end of said elongated body, which reduces the friction and facilitates easy disengagement of the coupling device from the nipple of the grease fitting.

An embodiment of the present invention discloses that clamping unit includes at least two jaws to engage and disengage with said nipple of said grease fitting.

An embodiment of the present invention discloses that lever includes a notch to provide grip to said lever.

An embodiment of the present invention discloses that rear end of said elongated body includes plurality of cavities facing away from said lever to enable gripping of said elongated body by said user.

An embodiment of the present invention discloses that rear end of said elongated body includes a recess facing said lever to provide space for the lever to be pressed downward.

An embodiment of the present invention discloses that rear end of said elongated body connects to an extension, providing better gripping and connection of the coupling device with the hosepipe.

An embodiment of the present invention discloses that lever is movably connected to said elongated body through said linkage mechanism that includes a pivot screw to movably connect said lever with said elongated body.

An embodiment of the present invention discloses that linkage mechanism includes a rivet that relatively moves with said roller to movably connect said lever with said slider.

An embodiment of the present invention discloses that lever moves said slider along said elongated body when said lever is pressed downward to move said roller connected with said rivet upward on said slider, resulting in pushing said slider axially forward.

An embodiment of the present invention discloses that elongated body includes a seal biased by a second spring and structured circumferentially on an inner surface of said passage to connect with said nipple to prevent leakage of fluid.

### BRIEF DESCRIPTION OF THE DRAWINGS

FIG. 1 represents an embodiment of the present invention depicting perspective view of coupling device.

FIG. 2 represents an embodiment of the present invention depicting side view of grease fitting with nipple.

FIG. 3a represents an embodiment of the present invention depicting front view of the coupling device with spherical heads.

FIG. 3b represents an embodiment of the present invention depicting sectional side view of the coupling device with spherical heads.

FIG. 3c represents an embodiment of the present invention depicting isometric view of coupling device with spherical heads covered by slider.

FIG. 4a represents an embodiment of the present invention depicting isometric view of coupling device with jaws.

FIG. 4b represents an embodiment of the present invention depicting front view of coupling device with jaws.

FIG. 4c represents an embodiment of the present invention depicting sectional side view of the coupling device with slider closing jaws.

FIG. 4d represents an embodiment of the present invention depicting sectional side view of the coupling device with slider opening jaws.

FIG. 5a represents an embodiment of the present invention depicting isometric view of coupling device with a notch on lever.

FIG. 5b represents an embodiment of the present invention depicting isometric sectional view of coupling device with recess and cavities on the elongated body.

FIG. 5c represents an embodiment of the present invention depicting isometric side view of coupling device with an extension connected at the rear end.

| Description of Elements | Reference Numeral |
|---|---|
| Coupling device | 10 |
| Elongated body | 20 |
| Front end | 22 |
| Cavities | 23 |
| Rear End | 24 |
| Extension | 25 |
| Passage | 26 |
| Recess | 27 |
| First Part | 28 |
| First Spring | 29 |
| Slider | 30 |
| Protrusion | 32 |
| Second Spring | 33 |
| Seal | 34 |
| Lever | 40 |
| Notch | 42 |
| Pivot Screw | 44 |
| Rivet | 46 |
| Roller | 48 |
| Clamping Unit | 50 |
| Spherical heads | 52 |
| Jaws | 54 |
| Grease fitting | 60 |
| Nipple | 62 |

### DETAILED DESCRIPTION

The embodiments of the present invention can be understood by reading following detailed description of some of the embodiments with reference to the accompanying drawings.

An embodiment of the present invention discloses a coupling device (10) that comprises of an elongated body (20), a lever (40) and a slider (30) axially movable between first position and the second position. The elongated body (20) includes a rear end (24) to which the hosepipe of the grease pumping equipment is connected, a front end (22) to which a grease fitting (60) is connected and a passage (26) between the front end (22) and rear end (24) of the coupling device (10) for fluids like grease, lubricant to flow through it and pass to the grease fitting through the connected nipple (62).

As shown in FIG. 1, the front end of the elongated body (20) has a clamping unit (50) that clamps the nipple (62) of the grease fitting (60), thereby connecting the coupling device (10) with the grease fitting (60). The rear end (24) of the elongated body (20) has an opening structured to receive the hosepipe for the grease to flow through the coupling device into the grease fitting. The elongated body (20) is also connected with the lever (40) near the rear end (24) through the linkage mechanism to enable easy engaging and disengaging of the grease fitting (60) with a clamping unit (50).

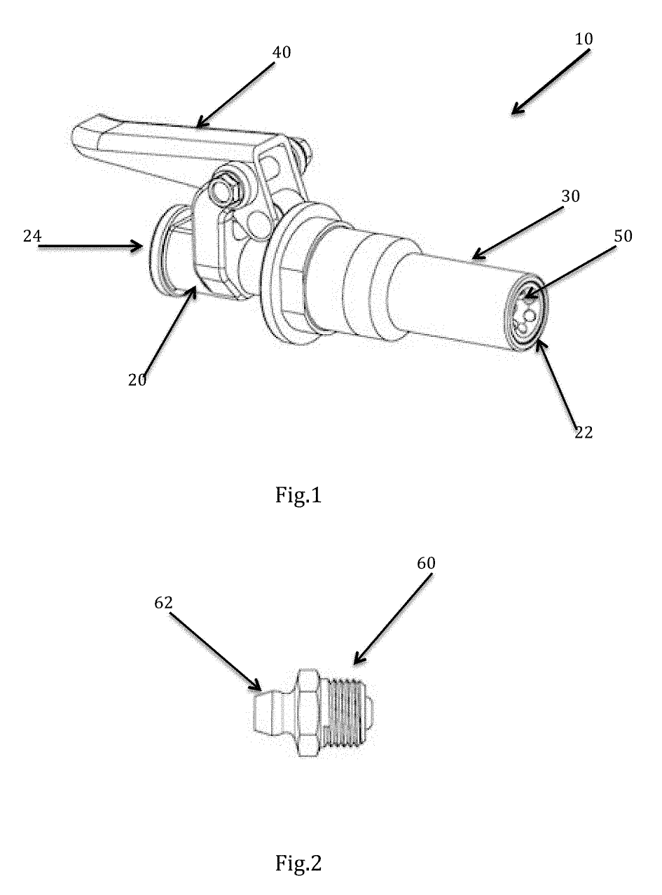

As shown in FIG. 2, the grease fitting (60) includes a nipple (62) that is structured to be received by the coupling device (10), which can be engaged to and disengaged from the coupling device (10). Once the nipple (62) is engaged with the clamping unit (50) of the coupling device (10), the grease fitting (60) and the coupling device (10) form a continuous path for the flow of grease from the hosepipe of the grease pumping equipment. Thereafter, when the action of greasing is completed, the nipple (62) of the grease fitting (60) can be disengaged from the clamping unit (50) of the coupling device (10).

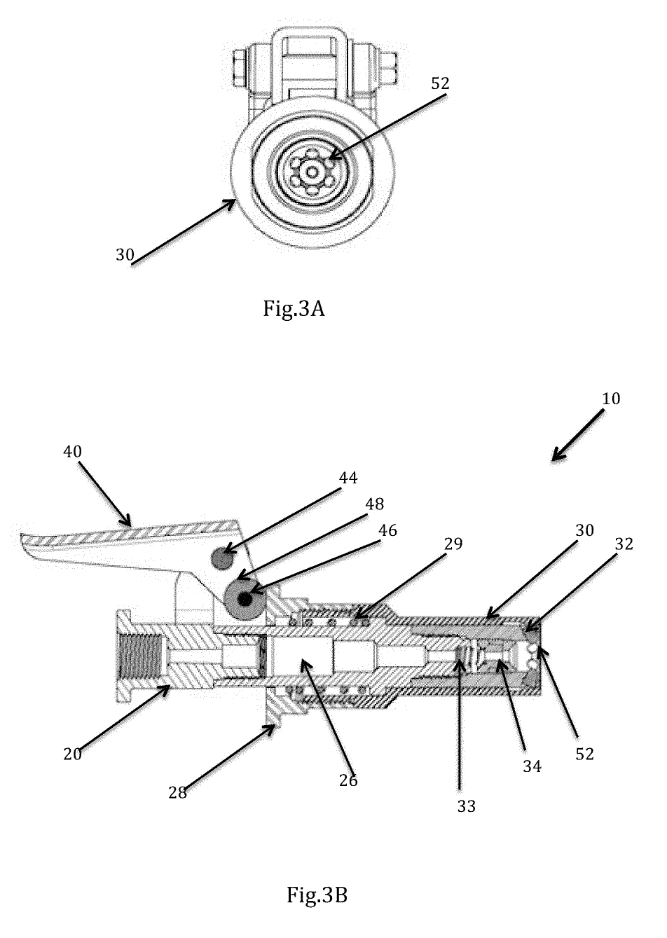

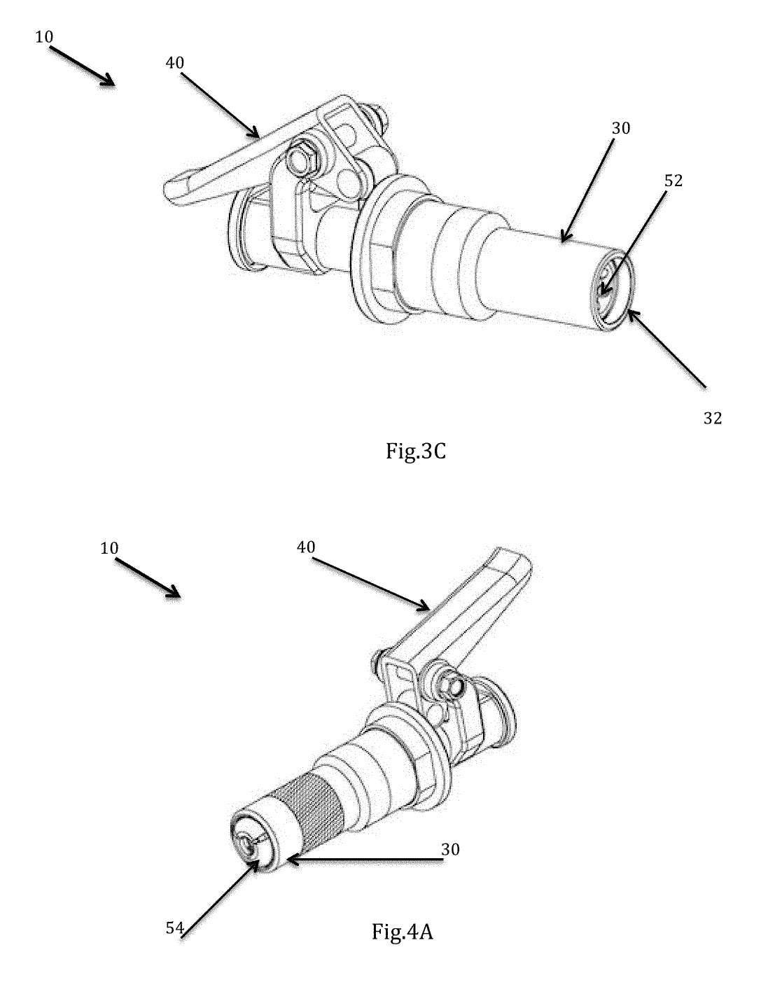

As shown in FIG. 3a, the clamping unit (50) includes a plurality of spherical heads (52) that is structured at the front end (22) of the elongated body (20) and connected with the slider (30) that is movable along the elongated body (20) between a first position and a second position to engage and disengage the nipple (62) of the grease fitting (60) with the spherical heads (52). The spherical heads (52) are structured at the inner surface of the front end (22) of the elongated body (20) to provide clamping of the nipple (62). The spherical heads (52) may include an extension that together with spherical head (52) forms a pin shaped structure.

As shown in FIGS. 3b and 3c, the elongated body (20) of the coupling device (10) includes a passage (26) that is formed between the front end (22) and the rear end (24) of the elongated body (20), allowing the grease to flow through it. The elongated body (20) is also connected with the lever (40) near to the rear end of the elongated body (20). The lever (40) is movably connected with the elongated body and the slider (30) through a linkage mechanism that includes a pivot screw (44), rivet (46) and a roller (48). The pivot screw (44) connects the lever (40) with the elongated body (20) near the rear end (24). The elongated body (20) has an extension to which the lever (40) is attached through the pivot screw (44) that enables the lever (40) to move when force is applied on the lever (40) being connected with the elongated body (20), thereby movably connecting the lever (40) with the elongated body (20). The rivet (46) and the roller (48) enable the lever (40) and the slider (30) to be movably connected with each other. The rivet (46) and the roller (48) are relatively movable with respect to each other and the rivet (46) being fixed to the lever (40). The rivet (46) has a circular surface of a circumference that is proportionate to the inner circumference of the roller (48) such that the roller (48) is movable on the rivet (46). The outer circumference of the roller (48) is in movable contact with a first part (28) of the slider (30) such that the roller (48) rolls on the edge of the first part (28) to move slider (30) forward and simultaneously pushing the slider (30) when the lever (40) receives a downward force.

The slider (30) is also biased by a first spring (29) that creates a springing action to move slider (30) forward when the lever (40) receives force to move downward. Once the force is applied on the lever (40), the slider (30) moves forward thereby pressing or compressing the first spring (29), and once the force applied on the lever (40) is released, the slider (30) comes back to its original position which is first position due to the pressure exerted by the first spring (29) to expand to its original shape. The slider (30) also includes a protrusion (32) near the front end of the elongated body (20) that applies pressure on the clamping unit (50) when the slider (30) is in the first position. Whereas, when the slider (30) is in second position, the protrusion (32) moves away from the clamping unit (50) to release the pressure from the clamping unit (50), thereby covering or enclosing the clamping unit (50).

When the user holds the coupling device (10) and applies force on the lever (40), the lever moves downwards being connected to the elongated body (20) through the pivot screw (44). Once the lever (40) moves downward, the roller (48) movably connected with the lever (40) through the rivet (44) moves upward from its initial resting position on elongated body (20). The roller (48) while moving upward, rolls on the first part (28) of the slider (30), which is in its first position. The roller (48) while rolling, pushes or applies force proportionate to the force received by the lever (40) to the first part of the slider (30), thereby pushing slider (30) from its first position to the second position i.e. the slider (30) moves axially forward on the surface of the elongated body. Simultaneously, the first spring due to the push or force received by the roller (48) expands and remains in the expanded position as long as the roller (48) pushes the slider (30) due to the force exerted on the lever (40). While reaching second position, the protrusion (32) moves forward along the elongated body (20) thereby releasing the pressure that was exerted on the spherical heads (52) or the clamping unit (50) when the slider (30) was in first position. The protrusion (32) forms a movable contact with the clamping unit (50) or the ball bearing (52), such that when the slider (30) reaches second position, the protrusion (32) covers or encloses the spherical heads (52) or clamping unit (50) within the elongated body (20) as shown in FIG. 3c. Once the slider (30) reaches the second position, clamping unit (50) or spherical heads (52) retracts or expands thereby forming space either to receive or to disengage with the nipple (62) of the grease fitting (60). Once the force applied on the lever (40) by a user is released, the lever (50) moves in the upward direction and the roller rolls back on the first part (28) of the slider (30) to move downward and rests on its initial position on the surface of elongated body (20). Once the force by the roller (48) is released, the slider (30) moves axially backward from its second position to first position when the first spring (29) contracts to come back to its original stable position, thereby, moving the protrusion (32) back to its original position on the clamping unit (50) or spherical heads (52) and thereafter continues applying pressure on the clamping unit (50) or spherical heads (52), resulting in compressing the clamping unit (50) or spherical heads (52) to engage the nipple (62) of the grease fitting (60) with the clamping unit (50) or spherical heads (52).

The elongated body (20) also includes a seal (34) that is structured circumferentially on an inner surface of the passage (26) of the elongated body (20). The seal (34) is structured substantially between the clamping unit (50) or spherical heads (52) and the inner surface of the passage (26). The seal (34) is biased by a second spring (33) structured in the passage (26) of the elongated body (20). The seal (34) is provided to seal the gap between the nipple's outer surface and the inner surface or inner circumference of the passage (26) to prevent leakage of fluid when the fluid like grease flows through the passage and the nipple (62) of the grease fitting (60) after the engagement of the nipple with the clamping unit (50) or spherical heads (52).

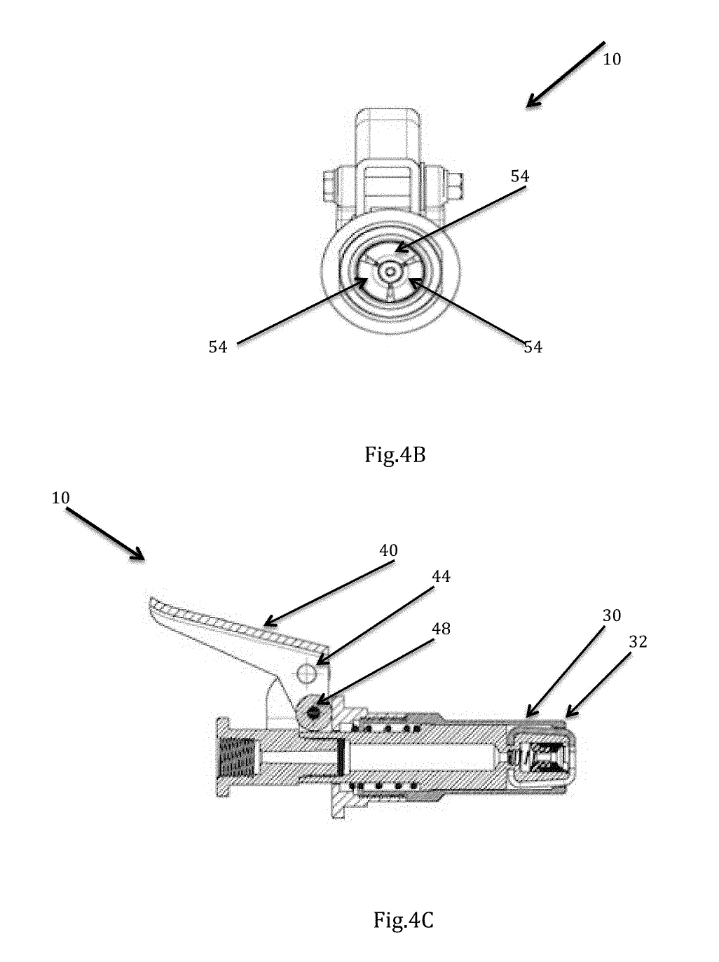

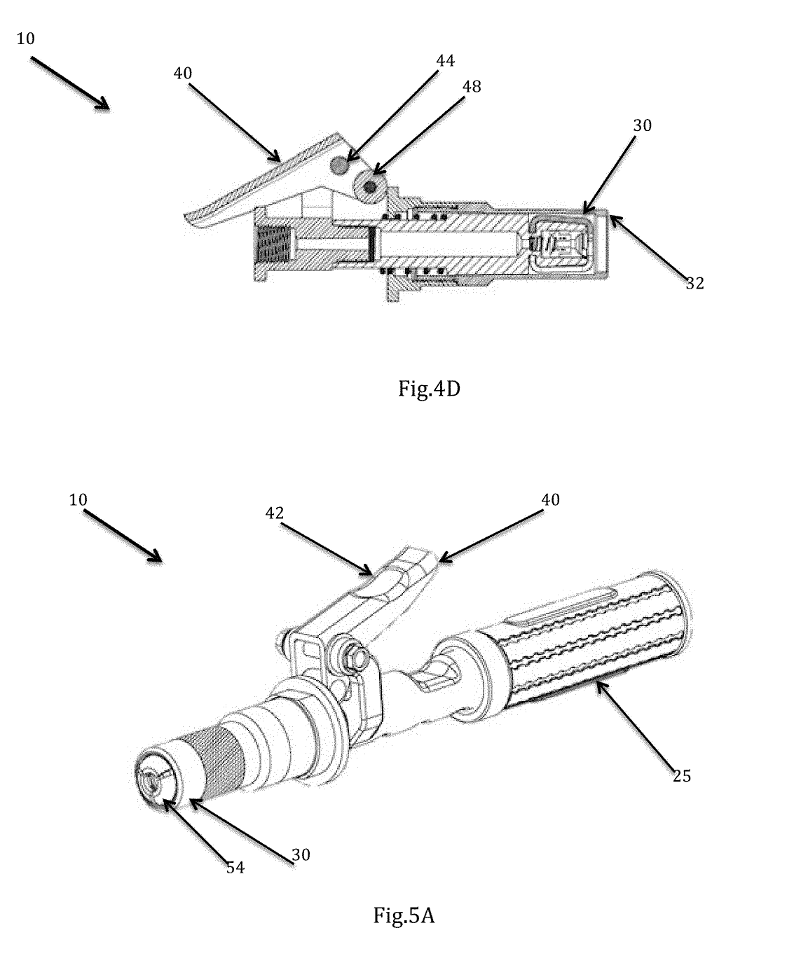

In an alternate embodiment as shown in FIGS. 4a and 4b, the clamping unit (50) can comprise of at least two jaws (54) and specifically three jaws (54) connected together from one end and openable from the opposite end can also clamp the nipple (62) of the grease fitting (60). The three jaws together forms a conical closure structured to receive the nipple (62) of the grease fitting to engage the coupling device (10) with grease fitting (60) and for the fluid to flow through it.

As shown in FIGS. 4c and 4d, when the lever (40) receives force by the user, the lever (40) moves downward and the roller (48) as discussed above moves upward and pushes the first part (28) of slider (30) forward, thereby moving the slider (30) axially forward from first position to second position, and expanding the first spring (29) with respect to the force received by the lever (40). The protrusion (32) structured at an end of the slider (30) opposite to the side facing lever applies pressure on the jaws (54) to engage the jaws with the nipple (62) or in contracted condition, when the slider (30) is in first position. Once the slider (30) is moved to the second position, the pressure exerted by the protrusion (32) is released as the protrusion (32) moves forward to the jaws (54) on the elongated body (20), thereby enclosing or covering the jaws (54) while in expanded or retracted condition of jaws (54) to receive or engage the nipple (62) or to disengage the nipple (62) with the coupling device (10). Once the force applied by the user is released, the lever (40) moves upward thereby moving the roller (48) downward, further resulting in axial backward movement of the slider (30) from second position to the first position, thereby moving the protrusion (32) backward along the elongated body (20) to continue applying pressure on the jaws (54) to enable gripping or contracting of the jaws (54) to engage the jaws with the nipple (62) of the grease fitting (60).

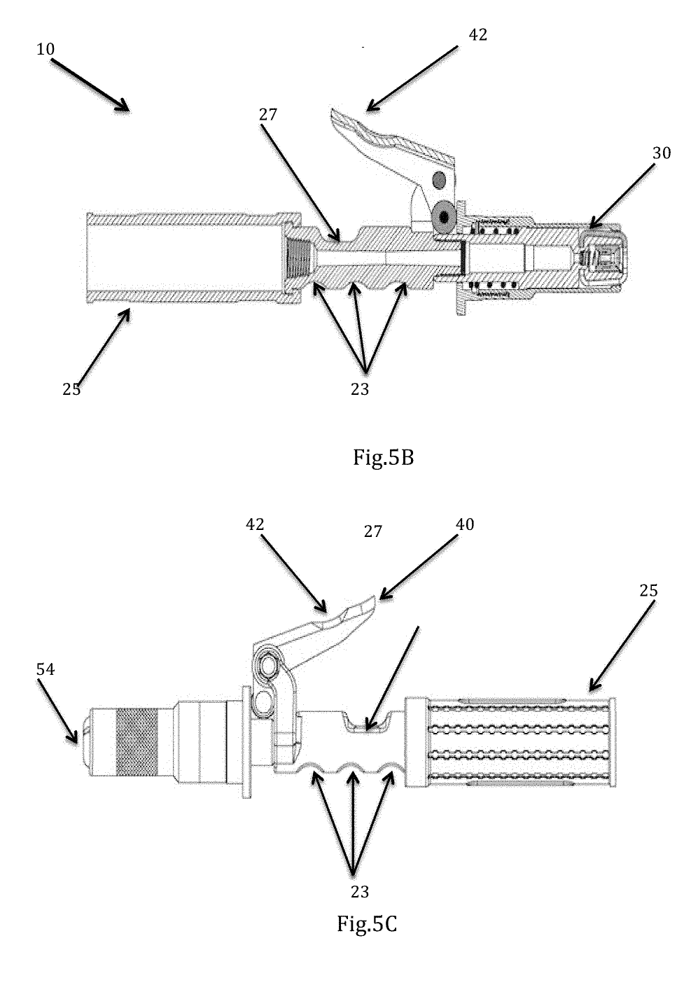

As shown in FIG. 5a, the lever (40) is provided with a notch (42) on its upper face, which is away the elongated body (20). This notch (42) provides an area for the user to use his thumb to ensure better gripping when using the coupling device (10) to engage or disengage the clamping unit (50) with the nipple (62) of the grease fitting (60).

As shown in FIGS. 5b and 5c, the lower surface of the elongated body (20) near the rear end (24) has three cavities (23) on the side opposite to the side facing the lever (40). These cavities (23) provide support to the fingers of the user to enhance the gripping of the coupling device (10). The upper surface of the elongated body includes a recess near the rear end. The recess (27) faces the lever (40) such that when the lever is pressed downward, at extreme downward condition of the lever (40), the recess (27) receives the lever (40) to ensure further smooth gripping of the coupling device (10). Further, the rear part (24) of the elongated body (20) is connected with an extension (25) that covers the hosepipe when connected to ensure proper protection when fluid like grease flows through the hosepipe and the coupling device (10).

The present invention is however not limited to the above embodiments disclosed above and referred in FIGS. 1 to 5 and other embodiments within the scope of the invention can be used for achieving the result of the present invention without limiting the scope of the invention.

1. A coupling device comprising:
an elongated body including a front end, a rear end and a passage between said rear end and said front end;
a slider with a protrusion axially movable along said elongated body between a first position and a second position on said elongated body;
a lever including a linkage mechanism with a roller that movably connects said lever to said slider to axially move said slider between said first position and said second position when force is applied by a user;
a clamping unit structured at said front end of said elongated body and detachably connected with said protrusion at an end of said slider opposite to said lever to engage and disengage with a nipple of a grease fitting,
wherein said slider moves axially forward along said elongated body from said first position to said second position to move said protrusion exerting pressure on said clamping unit thereby releasing pressure from said clamping unit to allow retraction of said clamping unit when force is applied on said lever by said user, and said slider moves axially backward along said elongated body from said second position to said first position to move said protrusion on said clamping unit to exert pressure on said clamping unit thereby contracting said clamping unit when force is released from said lever.

2. The coupling device as claimed in claim 1, wherein said clamping unit retract to disengage said nipple of said grease fitting with said elongated body, and said clamping unit contracts to engage said nipple of said grease fitting with said elongated body.

3. The coupling device as claimed in claim 1, wherein said clamping unit includes plurality of spherical heads structured circumferentially along an inner surface of said front end of said elongated body.

4. The coupling device as claimed in claim 1, wherein said clamping unit includes at least two jaws to engage and disengage with said nipple of said grease fitting.

5. The coupling device as claimed in claim 1, wherein said lever includes a notch to provide grip to said lever.

6. The coupling device as claimed in claim 1, wherein said rear end of said elongated body includes plurality of cavities facing away from said lever to enable gripping of said elongated body by said user.

7. The coupling device as claimed in claim 1, wherein said rear end of said elongated body includes a recess facing said lever.

8. The coupling device as claimed in claim 1, wherein said rear end of said elongated body connects to an extension.

9. The coupling device as claimed in claim 1, wherein said lever is movably connected to said elongated body through said linkage mechanism that includes a pivot screw to movably connect said lever with said elongated body.

10. The coupling device as claimed in claim 1, wherein said linkage mechanism includes a rivet that relatively moves with said roller to movably connect said lever with said slider.

11. The coupling device as claimed in claim 10, wherein said lever moves said slider along said elongated body when said lever is pressed downward to move said roller connected with said rivet upward on said slider, resulting in pushing said slider axially forward.

12. The coupling device as claimed in claim 1, wherein said elongated body includes a seal biased by a second spring and structured circumferentially on an inner surface of said passage to connect with said nipple to prevent leakage of fluid.
